(19) United States
(12) Patent Application Publication
(10) Pub. No.: US 2007/0229743 A1
(43) Pub. Date: Oct. 4, 2007

(54) ALIGNMENT METHOD

(76) Inventors: Chein-Wen Chen, Tainan City (TW); Hong-Wen Chuang, Taoyuan County (TW); Keng-Hao Chang, Taipei City (TW); Wen-Jhy Lin, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,535

(22) Filed: Apr. 4, 2006

(51) Int. Cl. G02F 1/1337

(52) U.S. Cl. 349/124

(57) ABSTRACT

An alignment method is described. First, an alignment layer material disposed on a substrate is provided. Then, a rubbing medium disposed on a surface of an alignment roller is provided, and the surface of the alignment roller is at a distance from the surface of the alignment layer material. The rubbing medium is used to align the alignment layer material, and the alignment roller is suitable for being driven by a torque and maintaining a particular rotating speed. There is a rate between the distance and the torque. When the torque of the alignment roller is larger or smaller than the range, the distance corresponding to the torque is calculated based on the rate. A distance difference value is deduced from the distance corresponding to the torque. Then, the distance is adjusted with the distance difference value.

### BACKGROUND OF THE INVENTION

1. Field of Invention

The present invention relates to an alignment method. More particularly, the present invention relates to an alignment method which can effectively improve uneven alignment of an alignment layer.

2. Description of Related Art

Nowadays, the development of multimedia technology mainly benefits from the development of semiconductor devices or display apparatuses. As to displays, LCD panels, having such characteristics as high resolution, space utilization, low power consumption, no radiation etc., have become the mainstream of display products in the market. A typical LCD panel mainly comprises two substrates and a liquid crystal layer disposed between the two substrates. Regardless of an active matrix LCD or a passive matrix LCD, alignment layers are disposed on both substrates thereof. The main function of the alignment layers is to align the liquid crystal molecules so that the liquid crystal molecules represent a twisted state between the two substrates.

The typical fabricating process of an alignment layer can be divided into thin film formation and alignment processing. Wherein the material for forming the alignment layer is generally hydrogenated diamond like carbon (DLC), silicon carbide (SiC), silicon oxide (SiO₂) etc., and the alignment process generally involves a rubbing method. To be specific, the operator aligns the alignment layer material formed on a substrate using the alignment cloth disposed on a roller to form a plurality of grooves on the surface of the alignment layer material to form the alignment layer. Accordingly, the liquid crystal molecules can be aligned along the grooves on the alignment layer.

Note that during the process of aligning the alignment layer material using alignment cloth, the depth of the alignment cloth pressed into the alignment layer material would affect the depth of the formed grooves directly, and uneven alignment of the alignment layer would happen no matter deeper or shallower the alignment cloth is pressed into the alignment layer material. In other words, the length of the alignment cloth and the distance between the surface of the roller and the surface of the alignment layer material are key factors in the yield of alignment.

Actually, the lengths of alignment cloth disposed on the roller are not identical, so conventionally, the average length of the alignment cloth is calculated first, and the required distance between the surface of the roller and the surface of the alignment layer material is estimated based on this average length to ensure that the depths of each alignment cloth pressed into the alignment layer material are identical. However, the distance estimated based on the average length is not precise if the lengths of the alignment cloth on the roller are too different. In this case, the operator would replace the alignment cloth and the roller; that is, alignment cloth of the same length is used to avoid uneven alignment. However, when the operator is replacing the alignment cloth and the roller, not only will it interrupt the whole manufacturing flow, and the throughput is accordingly decreased, but the consumption of material and manpower will also be increased.

Accordingly, another method is provided, wherein the relation curve between the torque required for driving the roller to spin at a fixed speed and the distance is deduced based on a tentative value and is used for adjusting the subsequent distance accordingly.

To be specific, originally, the required distance is estimated based on the average length of the alignment cloth and is used for aligning, and during the aligning process, the torque required for driving the roller to spin at a fixed speed is monitored. When the driving torque exceeds a tolerable range, which means the length of the alignment cloth is too different from the average length, the depth the alignment cloth pressed into the alignment layer material is either too deep or too shallow. Here, the distance between the surface of the roller and the surface of the alignment layer material needs to be adjusted to ensure the depth of the alignment cloth pressed into the alignment layer material is identical as before. But usually the distance is adjusted manually, which consumes manpower and may results in a situation that the adjusted distance still cannot meet the actual requirement due to human error.

### SUMMARY OF THE INVENTION

Accordingly, the present invention is directed to provide an alignment method, which can efficiently prevent uneven alignment to improve the yield of alignment of the alignment layer and reduce the manufacturing cost.

To accomplish the aforementioned and other objectives, the present invention provides an alignment method including the following steps: first, an alignment layer material disposed on a substrate is provided; then, a rubbing medium is disposed on the surface of an alignment roller, and the surface of the alignment roller is at a distance from the surface of the alignment layer material; next, the surface of the alignment layer material is aligned using the rubbing medium, the alignment roller is suitable for being driven by a torque and maintaining a particular rotating speed. Afterward whether the torque of the alignment roller falls within a range is determined. If the torque of the alignment roller is larger or smaller than the range, the following steps are executed: first a difference between the torque and the range is calculated, and a distance difference is deduced based on the rate between the difference of the torque and the distance difference; then, the distance between the alignment roller and the alignment layer material is adjusted based on the distance difference, so that the alignment roller can drive the rubbing medium with a torque within the range to align the alignment layer material.

According to the alignment method in an embodiment of the present invention, the distance difference, for example, is quadruple of the difference of the torque.

According to the alignment method in an embodiment of the present invention, the range is between about 0.2 and about 0.5 (Newton*centimeter).

According to the alignment method in an embodiment of the present invention, after deducing the distance difference and before adjusting the distance with the distance difference, the method further includes: first, setting a first distance extreme value; then, determining whether the adjusted distance is larger than the first distance extreme value. Wherein the distance is adjusted with the distance difference when the adjusted distance is smaller than or equal to the first distance extreme value.

According to the alignment method in an embodiment of the present invention, the first distance extreme value is, for example, the thickness of the rubbing medium.

According to the alignment method in an embodiment of the present invention, the first distance extreme value is, for example, 1.8 millimeters.

According to the alignment method in an embodiment of the present invention, after deducing the distance difference and before adjusting the distance with the distance difference, the method further includes: first, setting a second distance extreme value; then, determining whether the distance difference is larger than the second distance extreme value. Wherein the distance is adjusted with the distance difference when the distance difference is smaller than the second distance extreme value.

According to the alignment method in an embodiment of the present invention, the second distance extreme value is, for example, 0.05 millimeters.

According to the alignment method in an embodiment of the present invention, the distance is adjusted with the second distance extreme value as the distance difference when the distance difference is larger than or equal to the second distance extreme value.

According to the alignment method in an embodiment of the present invention, the material of the rubbing medium is, for example, alignment cloth.

According to the alignment method in an embodiment of the present invention, the material of the alignment cloth is, for example, soft polyester or polymer material.

According to the alignment method in an embodiment of the present invention, the alignment layer material includes an organic material or inorganic material.

According to the alignment method in an embodiment of the present invention, the inorganic material is, for example, silicon carbide or silicon oxide, and the organic material is, for example, polyimide compound.

In overview, the alignment method in the present invention uses a deduced distance difference to adjust the distance between the alignment roller and the alignment layer material, so that the rubbing medium can align the alignment layer material evenly, and the yield can be improved and the manufacturing cost can be reduced efficiently.

In order to make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a profile view illustrating how to align the alignment layer material according to the present invention.

FIG. 2 is a flowchart illustrating the alignment method in the first embodiment of the present invention.

FIG. 3 is a flowchart illustrating the alignment method in the second embodiment of the present invention.

### DESCRIPTION OF EMBODIMENTS

### The First Embodiment

FIG. 1 is a profile view illustrating how to align the alignment layer material according to the present invention. Referring to FIG. 1, first, an alignment layer material 212 disposed on a substrate 210 is provided. Wherein, the alignment layer material 212 includes an organic material or inorganic material. Some typical inorganic materials are, for example, silicon carbide (SiC) or silicon oxide (SiO2), and the organic materials are, for example, polyimide compound. Generally speaking, the substrate 210 may be a color filter substrate or active device array substrate.

Next, a rubbing medium 222 is disposed on the surface of an alignment roller 220 of an alignment machine (not shown). To simplify the figure and the description, only the alignment roller 220 is shown here. Furthermore, the surface of the alignment roller 220 is at a distance G from the surface of the alignment layer material 212. Generally speaking, the rubbing medium 222 can be divided into a hard medium and soft medium, wherein the hard medium is, for example, hard diamond compound, and the soft medium is, for example, alignment cloth fabricated from a soft polyester or polymer material. The operator can select the rubbing medium 222 according to the requirement of actual process. For the convenience of description, alignment cloth will be described as the rubbing medium 222 below, but it is not used to limit the material of the rubbing medium 222.

To be specific, the operator aligns the surface of the alignment layer material 212 with the rubbing medium 222. Note that when the alignment cloth (rubbing medium 222) aligns the alignment layer material 212, the alignment cloth (rubbing medium 222) will be pressed into the alignment layer material 212, and the alignment roller 220 is driven by a torque T and maintains a particular rotating speed. In detail, since the deeper the alignment cloth (rubbing medium 222) is pressed into the alignment layer material 212, the more the friction between the two is, thus to keep the alignment roller 220 spins at a particular speed, the torque T has to be altered along with the changing depth of the alignment cloth (rubbing medium 222) pressed into the alignment layer material 212. Moreover, the alteration of the distance G affects the depth of the alignment cloth (rubbing medium 222) pressed into the alignment layer material 212 directly. In other words, there is a rate between the variations of the distance G and the torque T. It should be noted that the rate between the variations of the distance G and the torque T may be varied according to the selected material of the rubbing medium 222. In this embodiment, when the torque T is varied, the distance has to be varied for quadruple of the variation of the torque T.

Generally speaking, there is an ideal range R for the distance G between the alignment roller 220 and the alignment layer material 212, and the alignment roller 220 can align the alignment layer material 212 evenly when it's working with a distance G within the ideal range. The ideal range R of the distance G corresponds to the range R of a torque T by the rate between the distance G and the torque T.

The alignment method in the present invention, which adjusts the distance automatically, is described in the following.

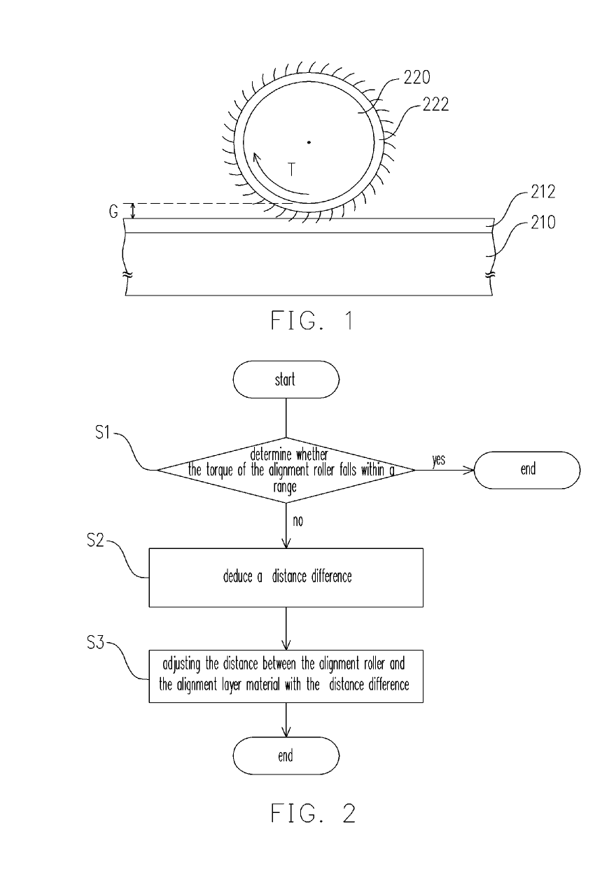

FIG. 2 is a flowchart illustrating the alignment method in the first embodiment of the present invention. Referring to both FIGS. 1 and 2, when the surface of the alignment layer material 212 is aligned by the alignment cloth ( rubbing medium 222), first, step SI is executed to determine whether the torque T of the alignment roller 220 falls within a range. When the torque T of the alignment roller 220 is larger or smaller than the range, which also means that the distance G between the alignment roller 220 and the alignment layer material 212 doesn't fall within the range, step S2 is executed. The aforementioned range R is, for example, between 0.2 and 0.5 (Newton*centimeter).

In step S2, first the difference between the torque and the range is calculated, and the distance difference AG is deduced based on a rate between a distance difference AG and the difference of the torque T. Next, as shown in step S3, the distance G between the alignment roller 220 and the alignment layer material 212 is adjusted based on the distance difference AG to ensure that the adjusted distance G can fall within the ideal distance range R and further the depth of the alignment cloth (rubbing medium 222) pressed into the alignment layer material 212 is an ideal value.

On the other hand, when torque T of the alignment roller 220 falls within the range, the compensating step is not executed. That means the distance G between the surface of the alignment roller 220 and the surface of the alignment layer material 212 falls within the ideal range, thus the rubbing medium 222 can align the alignment layer material 212 evenly.

The alignment method of the present invention can be implemented with a program language, and the program is installed in the operating software of an alignment machine (not shown) to adjust the alignment machine (not shown) appropriately to meet the operational requirements thereof. With the alignment method of the present invention, the distance G between the surface of the alignment roller 220 and the surface of the alignment layer material 212 can be adjusted automatically to an ideal value. Compared with the conventional technology, the alignment method of the present invention can prevent uneven alignment efficiently, the manufacturing flow will not be interrupted during the process of adjusting the distance G, and there will be no human error, and there will be no need to replace the alignment roller 220 and the alignment cloth. Therefore, the alignment method in the present invention can not only improve the certified rate and the production capacity, but also reduce the manufacturing cost.

### The Second Embodiment

In addition to the main flow described in the first embodiment (as shown in FIG. 2), other flows may also be added into the alignment method of the present invention to meet the requirements of actual situations. The present embodiment is similar to the second embodiment, wherein the main difference is: in the present embodiment, some processes are added to meet the requirements of the actual situation after the distance difference AG has been deduced. This will be described in detail below.

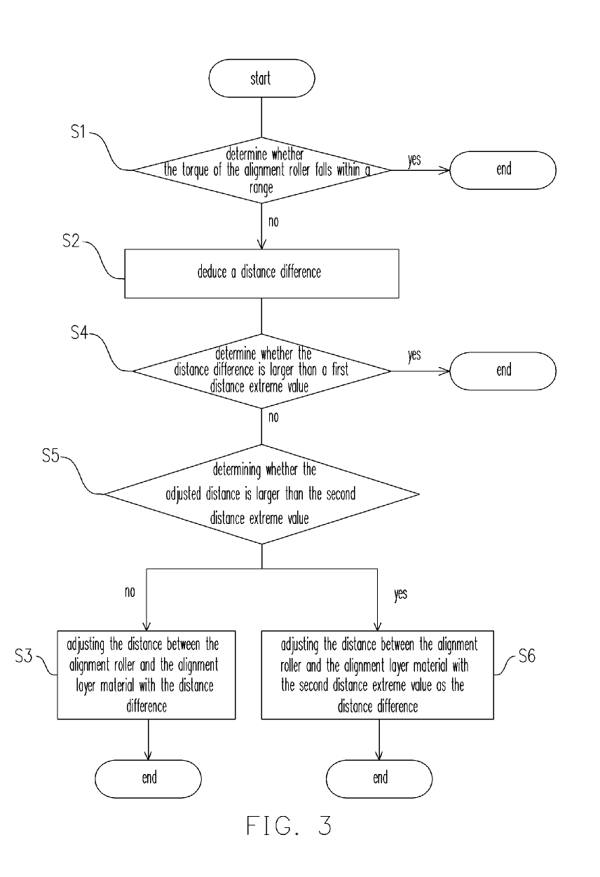

FIG. 3 is a flowchart illustrating the alignment method in the second embodiment of the present invention. Referring to FIG. 3, before adjusting the distance G based on the distance difference AG (step S3), the following steps are further included: first, the operator can set a first distance extreme value D1 based on the thickness of the rubbing medium 222, wherein the first distance extreme value D1 is, for example, 1.8 millimeters; then, step S4 is executed to determine whether the adjusted distance G is larger than the first distance extreme value D1. The compensating step is not executed if the adjusted distance G is larger than the first distance extreme value D1. This is because if the adjusted distance G is larger than the first distance extreme value D1 (the thickness of the rubbing medium 222), the rubbing medium 222 will not be able to touch the alignment layer material 212, accordingly the rubbing medium 222 will not be able to align the alignment layer material 212. On the other hand, the distance G is adjusted with the distance difference AG when the adjusted distance G is smaller than or equal to the first distance extreme value D1.

Certainly, different settings may be added to the alignment method of the present invention according to the limitation of operation or refitting of different alignment machines (not shown). For example, before adjusting the distance G with the distance difference AG (step S3), the following steps may be further included: first, setting a second distance extreme value D2, which may be altered according to the type and the limitation of operation or refitting of the alignment machine (not shown), and the second distance extreme value D2 is, for example, 0.05 millimeters.

Continue to execute step S5 to determine whether the distance difference AG is larger than the second distance extreme value D2 when the adjusted distance G is smaller than or equal to the first distance extreme value D1. Execute step S3 and adjust the distance G with the distance difference AG when the distance difference AG is smaller than the second distance extreme value D2. On the other hand, execute step S6, and adjust the distance G with the second distance extreme value D2 (0.05 millimeters) as the distance difference AG when the distance difference AG is larger than or equal to the second distance extreme value D2.

In overview, the alignment method of the present invention has at least the following advantages:

1) According to the alignment method in the present invention, the distance between the alignment roller and the alignment layer material is compensated with a deduced distance difference to be adjusted into an ideal range. Therefore, the alignment method in the present invention can prevent uneven alignment of the alignment layer efficiently and so can improve the certified rate of the process.

2) According to the alignment method in the present invention, the distance can be adjusted automatically, without interrupting the process of the LCD panel afterwards, and there will be no human error and waste of material. Accordingly, the alignment method in the present invention can improve the production yield and reduce the manufacturing cost.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An alignment method, comprising:
providing an alignment layer material disposed on a substrate;
providing a rubbing medium disposed on the surface of an alignment roller, the surface of the alignment roller being at a distance from the surface of the alignment layer material;
aligning the surface of the alignment layer material with the rubbing medium, the alignment roller being suitable for being driven by a torque and maintains a particular rotating speed to spin;
determining whether the torque of the alignment roller falls within a range, wherein when the torque of the alignment roller is larger than or smaller than the range, the following steps are executed:
calculating a difference between the torque and the range; and
adjusting the distance between the alignment roller and the alignment layer material with the distance difference to ensure that the alignment roller drives the rubbing medium with a torque within the range to align the alignment layer material, wherein there is a rate between the difference of the torque and the distance difference.

2. The alignment method as claimed in claim 1, wherein the distance difference is quadruple of the difference of the torque.

3. The alignment method as claimed in claim 1, wherein the range is between about 0.2 and about 0.5 (Newton*centimeter).

4. The alignment method as claimed in claim 1, wherein after deducing the distance difference and before adjusting the distance with the distance difference, the method further comprising:
setting a first distance extreme value; and
determining whether the adjusted distance is larger than the first distance extreme value, wherein the distance is adjusted with the distance difference afterwards when the adjusted distance is smaller than or equal to the first distance extreme value.

5. The alignment method as claimed in claim 4, wherein the first distance extreme value is the thickness of the rubbing medium.

6. The alignment method as claimed in claim 4, wherein the first distance extreme value is about 1.8 millimeters.

7. The alignment method as claimed in claim 1, wherein after deducing the distance difference and before adjusting the distance with the distance difference, the method further comprising:
setting a second distance extreme value; and
determining whether the distance difference is larger than the second distance extreme value, wherein the distance is adjusted with the distance difference when the distance difference is smaller than the second distance extreme value.

8. The alignment method as claimed in claim 7, wherein the distance is adjusted with the second distance extreme value as the distance difference when the distance difference is larger than or equal to the second distance extreme value.

9. The alignment method as claimed in claim 7, wherein the second distance extreme value is about 0.05 millimeters.

10. The alignment method as claimed in claim 1, wherein the material of the rubbing medium comprises alignment cloth.

11. The alignment method as claimed in claim 10, wherein the material of the alignment cloth is soft polyester or polymer material.

12. The alignment method as claimed in claim 1, wherein the alignment layer material comprises an organic material or inorganic material.

13. The alignment method as claimed in claim 12, wherein the inorganic material is silicon carbide or silicon oxide compound.

14. The alignment method as claimed in claim 12, wherein the organic material is polyimide compound.
